(19) United States
(12) Patent Application Publication
(10) Pub. No.: US 2015/0192971 A1
(43) Pub. Date: Jul. 9, 2015

(54) High power portable device and docking station

(71) Applicant: Bhavesh Ramesh Shah, San Diego, CA (US)

(72) Inventor: Bhavesh Ramesh Shah, San Diego, CA (US)

(21) Appl. No.: 14/588,987

(22) Filed: Jan. 5, 2015

Related U.S. Application Data
(60) Provisional application No. 61/924,858, filed on Jan. 8, 2014.

(51) Int. Cl. G06F 1/20; G06F 1/16

(52) U.S. Cl. CPC G06F 1/203; G06F 1/1632

(57) ABSTRACT

A system includes a high performance but very compact computer processing module and an associated docking station. The module includes a processor that is contained within an outer housing. The outer housing defines a heat transmission surface that is thermally coupled to the processor and other heat generating components in the module. The docking station includes a receiving portion for receiving a portion of the outer housing of the module. The docking station also includes a thermally conductive substrate defining a heat receiving surface which aligns with the heat transmission surface when the module is installed to the receiving portion. An array of conductive fibers thermally couples the heat transmitting surface to the heat receiving surface. This forms a dry low pressure thermal coupling interface with high reliability with repeated thermal coupling and decoupling. This is advantageous relative to traditional semi liquid or liquid thermal compounds or compliant thermal pads which require high pressure coupling or unreliable repetitive thermal coupling and decoupling. The high performance computing processor is detached from heatsink and fan, and hence is compact enough to enable a person to carry a high performance computer in their pocket.

### CROSS-REFERENCE TO RELATED APPLICATIONS

This non-provisional patent application claims priority to U.S. Provisional Application Ser. No. 61/924,858, entitled “COMPUTER DOCKING STATION AND METHOD,” filed on Jan. 8, 2014, incorporated herein by reference under the benefit of U.S.C. 119(e).

### FIELD OF THE INVENTION

The present invention relates generally to high power portable devices such as portable computers which can include portable processing modules for servers. More particularly it relates to a very compact hand-held computer that utilizes processing chips that up until now were only used in high performance laptop, desktop, server, and workstation computers.

### BACKGROUND

Recent advances in personal computers has been bifurcated between increasing performance and increasing portability. Performance is being pursued by “desktop” and “laptop” computers that typically entail very high performance multi-core and multi-threading processors. These processors generate large amounts of heat during operation, requiring extensive cooling systems. Such cooling systems include thermal conductors for removing heat from the processors that are coupled to active convective cooling systems such as a fan that transport air past a cooling fin array.

At the same time, the desire for portability has resulted in increasingly thin and light computing devices. This has reached an extreme with ultra-thin laptops, tablet computing devices, and smart phones. Such systems generally cannot be designed with active cooling systems. Yet at the same time there is a desire for these highly portable devices to have increasing performance.

Processor designers have tried to address this bifurcation by attempting to achieve the parallel goal of both performance and lower power dissipation. This has resulted in some high performance processors that are acceptable for some laptop computers. Yet despite these advances, compromises are made. Some of these laptops are designed from aluminum and have active cooling and yet still exhibit high thermal excursions during operation that result in noticeably hot exteriors during operation.

In addition, there is a desire to be able to utilize computers that are thinner and smaller than even the typical laptop computer. This likely precludes the use of active cooling systems which in turns relegates such computers to lower powered processors.

In the past there has been an attempt to close this bifurcation between performance and portability using docking stations that offer cooling. U.S. Pat. No. 5,473,506, to be referred to as “the '506 patent,” describes one such system. The '506 patent describes a modular computer with docking bays for receiving functional modules having microprocessors that generate waste heat. The bays are shown having cooling structures that engage the functional modules to remove the waste heat. One challenge with such system is the effectiveness in transferring heat from the processor to the dock and in removing the waste heat.

One aspect of this challenge is illustrated in FIG. 1. Prior art heat removal systems can involve an interface 2 for conducting heat from a heat generating portion 4 to a heat receiving portion 6. Optimally the heat generating portion 4 and heat receiving portion 6 is formed from materials having relatively high thermal conductivity such as aluminum. Yet despite this, a key difficultly lies in the interface 2. At a microscopic level, heat generating portion 4 typically defines a very rough surface 8, which includes surface waviness also. Likewise, heat receiving portion 10 also defines a very rough surface 10, which includes surface waviness also. When these surfaces 8 and 10 are pressed together they tend to only make point contacts, resulting in a large thermal resistance between them. Between them is an air gap 12 over most of the surface area. Portions 4 and 6 can be made of copper which has a thermal conductivity of 400 watts per meter-degree Kelvin. However the air gap 12 dominates the thermal resistance because it has a thermal conductivity of about 0.02 Watts per meter-degree Kelvin. Thus the high conductivity of portions 8 and 10 does not enable effective heat transfer at interface 2.

One possible solution is to attempt to make the surfaces 8 and 10 microscopically perfect. This is, unfortunately impractical in terms of high cost and in actual use. Moreover during use of these components the surfaces 8 and 10 are likely to become contaminated and scratched thus re-creating the adverse effect of the rough surfaces. Reliance on a perfect surface is likely to have a disastrous result if the surface perfection becomes compromised.

Other possible solutions include the use of a compliant polymer such as a rubber material that spans the air gap 12. The difficulty with this is that, in order for the polymer to have enough compliance to conform to both surfaces 10 and 12, the thickness has to be to an extent as to create a large thermal resistance. The so called “thermally conductive” polymers have order(s) of magnitude lower thermal conductivity, and because they are filled with a filler material, are stiffer. The clamping force required to conform a polymer layer to these surfaces may be impractical if it is made thin enough to make thermal resistive losses tolerable. Rubber materials can also be filled with thermally conductive fillers. The so called “thermal interface pads” which include polymer pads and graphite pads exhibit mechanical properties that are unsuitable for repeated reliable thermal coupling and uncoupling cycles during docking and undocking respectively.

Yet other possible solutions involve the use of thermal greases to span the air gap 12. This has the disadvantage that repeated thermal coupling and decoupling cycles will tend to deplete or reduce effectiveness of the thermal grease requiring its reapplication. Many users cannot be expected to have such thermal grease on hand or to properly apply it.

Thus there is a need to find better thermal solutions in order to enable the use of the high power portable devices such as high performance portable computers.

### BRIEF DESCRIPTION OF THE FIGURES

FIG. 1 is a schematic representation of two surfaces that are pressed together illustrating a point contact that occurs due to surface roughness.

FIG. 2 is a schematic representation of an exemplary system according to the present invention.

FIG. 3 is an isometric view of an exemplary embodiment of a high performance portable computer about to be installed to a docking station.

FIG. 4 is an isometric view of an exemplary embodiment of a high performance portable computer installed to a docking station.

FIG. 5 is a schematic representation of a first embodiment of a low force thermal coupler that utilizes thermally conductive fibers engaging a compliant surface.

FIG. 5A is a schematic representation of a single conductive fiber that is impinging upon a rough surface.

FIG. 5B is a schematic representation of a single conductive fiber that is impinging upon a rough surface that includes a compliant layer.

FIG. 6 is a schematic representation of a low force thermal coupler that utilizes inter-engaging overlap of thermally conductive fibers.

FIG. 6A is a schematic representation depicting inter-engaging overlap of conductive fibers with greater detail than FIG. 6.

FIG. 7 is a schematic representation of a system utilizing thermally conductive fibers having a flared end geometry.

FIG. 8 depicts a system in which a high performance portable computer is to be installed into a receptacle of a docking station with particular emphasis on mechanical features interact during the installation to provide motion control, alignment, and stability.

FIG. 9 is an isometric representation of an alternative geometry of a system with a high performance portable computer installed into a docking station.

FIG. 10 is an isometric representation of another alternative embodiment of a system in which the high performance portable computer can function at a lower power level without being installed in a docking station.

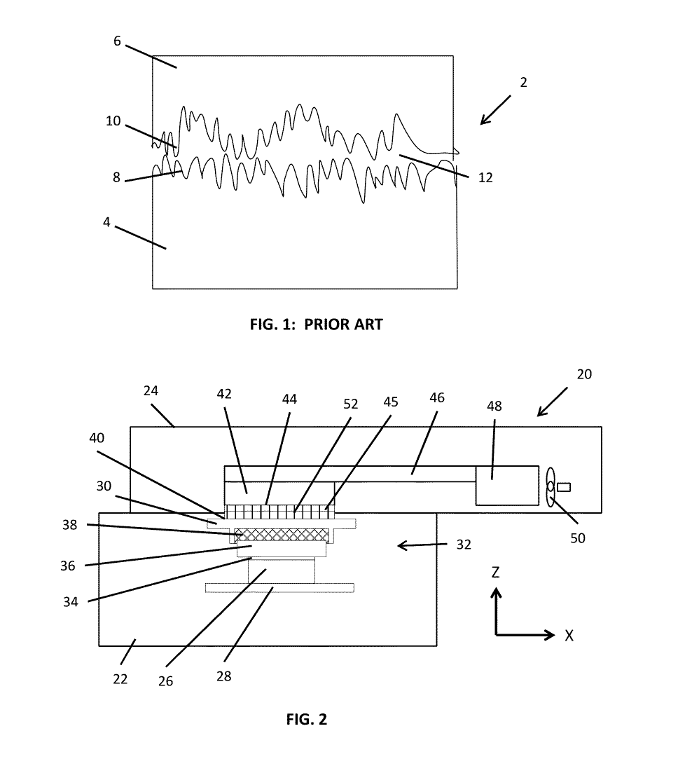

### DETAILED DESCRIPTION OF THE PREFERRED EMBODIMENTS

In this description, any directional prepositions such as up, upwardly, down, downwardly, front, back, top, upper, bottom, lower, left, right and other such terms refer to the device or depictions as such may be oriented are describing such as it appears in the drawings and are used for convenience only. Such terms of direction and location are not intended to be limiting or to imply that the device or method herein has to be used or positioned with graphics in any particular orientation. Further computer and network terms such as network, server, computer, portable, device, database, browser, media, digital files, and other terms are for descriptive purposes only, and should not be considered limiting, due to the wide variance in the art as to such terms depending on which practitioner is employing them. The system herein should be considered to include any and all manner of software, firmware, operating systems, executable programs, files and file formats, databases, computer languages and the like, as would occur to one skilled in the art in any manner as they would be described.

FIG. 2 is a schematic representation of an exemplary system 20 according to the present invention. Details are omitted for clarity of illustration and description. System 20 generally includes a high power portable device exemplified here as a high performance portable computer (“module”) 22 and a docking station 24. Axes X and Z are referred to as lateral and vertical axes respectively and are generally orthogonal to each other. The docking station can be a standalone or can form a part of another system including server, cash register, Point of sale system, kiosk, digital signage, vehicle, display system, robot, and industrial system.

Module 22 includes a processor (CPU) 26 mounted to a printed circuit board (PC board) 28. The PC board 28 is an exemplification of a heat generating apparatus. Module 22 also includes an housing 30, a portion of which is depicted is formed from a thermally conductive material such as a highly thermally conductive metal or metallic alloy. Suitable materials for housing 30 include aluminum, copper, and magnesium alloys. A heat transfer element 32 thermally couples the processor 26 to the housing 30. Heat transfer element 32 can include one or more components. In an illustrative embodiment heat transfer element 32 includes a thermally conductive adhesive 34, a copper heat spreader 36, and a thermally conductive gel 38. The thermally conductive gel 38 helps absorb shock and vibration and fills gaps due to mechanical tolerance variations. Housing 30 also defines a heat transmission surface 40 on a portion of the housing 30 that is preferably roughly aligned relative to the processor 26 to maximize heat transfer. In some embodiments an thermal interface element (not shown) is disposed upon the heat transmission surface 40. Examples of such a heat transfer element can include a compliant layer or an array of thermally conductive fibers which is to be discussed later.

Docking station 24 includes a thermally conductive substrate 42 that defines a heat receiving surface 44 for receiving heat from heat transmission area 40. Heat transmission surface 40 and heat receiving surface 44 overlap over a heat transfer area 45. In a preferred embodiment thermally conductive substrate 42 is formed from a thermally conductive material such as a highly thermally conductive metal or metallic alloy. Suitable materials for outer thermally conductive substrate 42 include aluminum, copper, and magnesium alloys to name a few examples. Thermally conductive substrate 42 is thermally coupled to a thermal conduction path 46. Thermal conduction path 46 can be a heat pipe or a solid thermal conductor such as a metal or metal alloy. In one embodiment thermally conductive substrate 42 and thermal conduction path 46 are integrally formed of one material. Thermal conduction path is thermally coupled to a heat exchanger 48 such as a set of aluminum fins. A fan 50 is configured to blow air through heat exchanger 48 so as to provide convective heat removal.

Between heat transmission area 40 and heat receiving area 44 is a low force thermal coupler 52 that includes a plurality of heat conducting fibers whose lateral extent defines the heat transfer area 45. Thermally conductive fibers are generally very effective in transmitting heat along the vertical axis Z. The fibers are oriented to generally define an average angle with surfaces 40 and 44 that is at least about 30 degrees. The heat conducting fibers may be straight or bent. Typically they are bent in a non-linear fashion. The fibers may project from either or both of surfaces 40 and 44. When the fibers project from one surface 40 or 44, the opposing surface can include a compliant feature that enables effective thermal coupling between the projecting fibers and the opposing surface. The material of such a compliant layer can include silicone or urethane rubbers. While such layers have very low thermal conductivity typically below 1 watt per meter kelvin, their thickness can be less than 100 microns and in one embodiment less than 25 microns. A compliant layer thus helps reduce contact thermal resistance significantly while only adding a moderate thermal resistance due to its low thickness. In a first embodiment the fibers are carbon fibers. In a second embodiment the fibers are polymer fibers. In a third embodiment each fiber is a polymer fiber having a thin thermally conductive coating that improves heat transfer in a lateral direction that is transverse to the long axis of the fiber.

In a preferred embodiment the low force thermal coupler 52 provides heat transfer between without the use of any “wet” components such as thermal grease that would tend to deplete with repeated thermal couplings and disconnections. Thus a thermal connection between housing 30 and thermally conductive substrate 42 is preferably a “dry” connection without the use of thermally conductive greases or other thermally conductive fluids. This “dry” aspect promotes greater interface longevity without user maintenance.

In an exemplary embodiment the heat transfer area 45 is at least about 10 square centimeters in area. In one particular embodiment the area is about 40 square centimeters. The area 45 can be chosen based on the amount of heat that needs to be transferred and the permissible temperature drop desired between surfaces 40 and 44.

In use excess heat is generated by the processor 26 during operation of module 22. Through heat transfer element 32 the heat is transmitted to housing 30. The heat is then transferred from heat transmitting surface 40 to heat receiving surface 44 by the fibers that form at least a portion of thermal coupler 52. The heat is then transmitted through conductive substrate 42 and thermal conduction path 46 to heat exchanger 48 and convectively removed using fan 50.

In an exemplary embodiment the processor 26 generates at least 8 watts of excess heat. In other embodiments the processor 26 generates at least 10, at least 15, at least 20, at least 25, about 25, or more than 25 watts of excess heat. A processor 26 generating waste heat of 50 watts may be used. Given a desire to keep advancing processor performance in computers, higher amounts of excess heat may be generated.

A waste heat transferred per square centimeter can defined by dividing the heat power transferred divided the area of the heat transfer area 45 measured in centimeters. For example, consider a processor that generates 40 watts in waste heat and an area of 40 square centimeters. This would result in a watt per square centimeter of 1 Watt per square centimeter being transferred across area 45 and through thermal coupler 52.

Using the system 20, a temperature drop from the heat transmission surface to the heat receiving surface is minimized to less than ten degrees Celsius for every watt per square centimeter transmitted across the heat transfer area 45. In other embodiments the temperature drop is less than six, less than five, less than four, or less than three degrees Celsius for every watt per square centimeter transmitted across the heat transfer area 45. In some embodiments the temperature drop can be between two to three degrees Celsius for every watt per square centimeter transmitted across the heat transfer area 45.

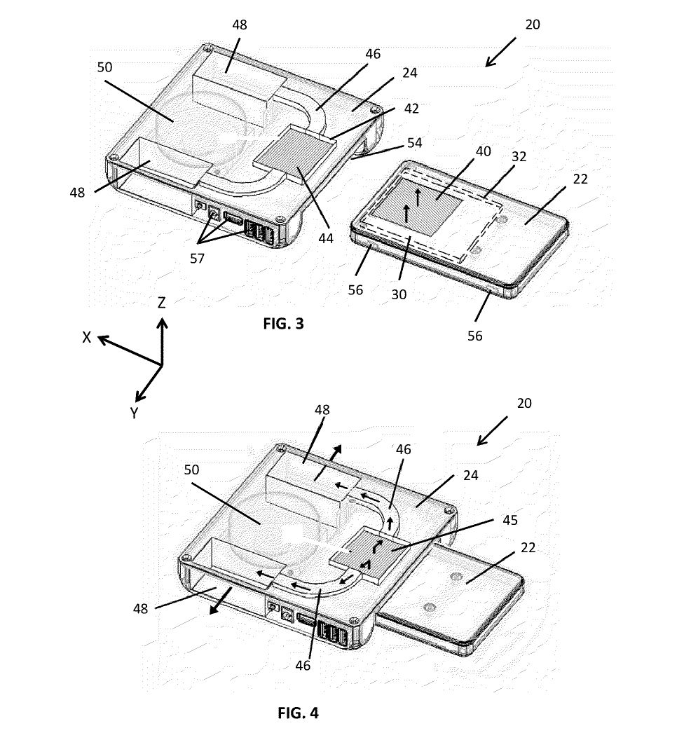

FIG. 3 is an isometric view of an exemplary embodiment of system 20 with module 22 and docking station 24 separated. Axes are illustrated including lateral axes X and Y and vertical axis Z. The direction of +X is a direction of installation of module 22 into dock 24. The direction of +Z is a direction of heat transfer from module 22 to dock 24.

Various features that were schematically illustrated with respect to FIG. 2 are now illustrated in more of an exemplary embodiment form. As indicated a heat transfer element 32 is within module 22 below which is a processor 26 (not shown). The heat transfer element 32 may include a copper or aluminum sheet or heat sink. Heat transfer element 32 transfers heat to a portion of an housing 30 which defines heat transmission surface 40.

Docking station 24 is depicted including heat receiving surface 44, thermal conductive path 46, heat exchanger 48, and fan 50. Docking station 24 includes a receptacle 54 for receiving, aligning, securing, and coupling to module 22. Receptacle 54 defines an opening for receiving module 22 along the +X direction. Installation of module 22 into receptacle 54 can include a sliding engagement installation. Module 22 can include datum 56 along edges or top of housing 30 that are engaged by complementary alignment features (not shown) that are part of receptacle 54 that serve the purpose of properly aligning module 22 to receptacle 54 in X, Y, and Z. This alignment can be important to properly align heat transmission surface 40 to heat receiving surface 44 in all three axes. Receptacle 54 may also include or define latching or frictional features for securing module 22 in proper alignment. Finally receptacle 54 can include an electrical connector (not shown) for electrically coupling module 22 to docking station 24.

FIG. 3 depicts an exemplary receptacle 54 as a cavity or opening for receiving a portion of module 22. In an alternative embodiment the docking station 24 can include a receiving portion 54 that is not a cavity or opening. For example, such a receiving portion 54 can be formed into an upper surface of docking station 24 whereby module 22 can be placed onto the receiving portion 54. Other variations are possible for receiving portion 54.

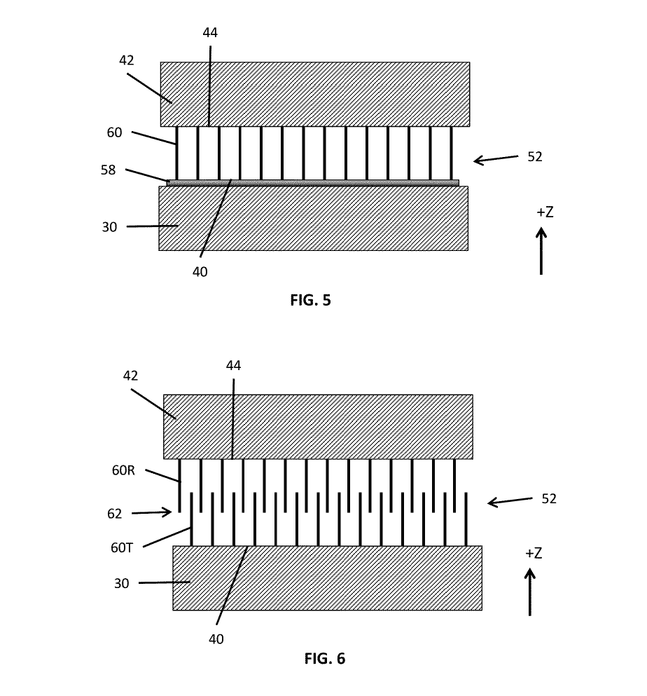

FIG. 4 is an isometric view of an exemplary embodiment of system 20 with module 22 installed in receptacle 54. Heat transmission surface 40 and heat receiving surface 44 are overlaid to define heat transfer area 45. Heat transfer area 45 is an area of overlap between heat transmission surface 40 and heat receiving surface 44 over which the surfaces are joined by a low force thermal coupler 52.

Waste heat is generated in processor 26 and the vertical direction of the heat motion along +Z is illustrated in FIGS. 3 and 4. The waste heat is thereby vertically conducted from the processor, through the heat transfer element 32, through a portion of the housing 30, through the low force thermal coupler 52, and to the thermally conductive substrate 42. The waste heat is then laterally conducted along the X and Y axes along the thermal conduction path 46 to heat exchanger 48. The waste heat is then transferred from heat exchanger 48 to surrounding air via forced convection through fan 50.

While particular emphasis has been placed on features of docking station 24 that facilitate heat removal, it is understood that docking station can provide various other functions such as providing power to module 22 and providing connectivity between module 22 and other systems and devices. Such connectivity can include connectivity to a monitor or printer, wireless connectivity, and connectivity to computer networks. FIGS. 3 and 4 depict various ports 57 which can include power ports, camera card ports, headset ports, USB (universal serial bus) ports, Firewire ports, and/or Ethernet ports, just to name a few examples. Docking station 24 may also include one or more antennas for wireless communication utilizing one or more protocols such as Bluetooth, 802.11, and cellular communication to name a few examples.

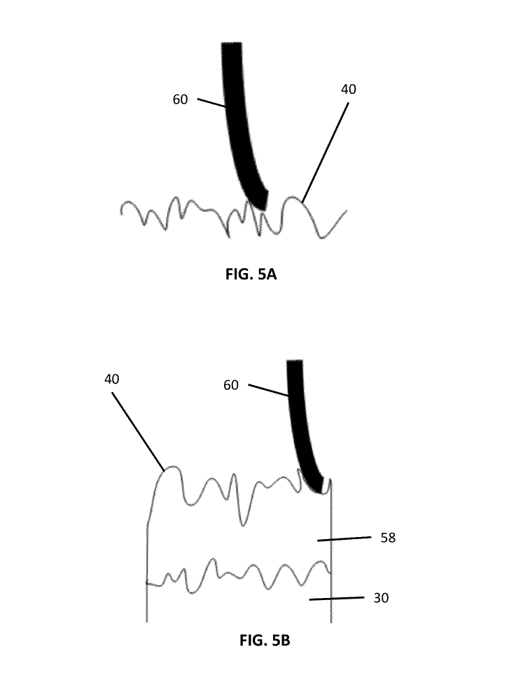

FIGS. 5, 5A, 5B, 6, 6A, and 7 are schematic representations that depict embodiments of low force coupler 52. In any of these designs there are fibers that project either from the heat transmitting surface 40, the heat receiving surface 44, or from both surfaces 40 and 44 depending on the specific embodiment. Generally speaking these fibers have a long axis that generally extends vertically along Z. As indicated earlier, these fibers may define acute angles relative to Z or be nearly coincident with Z and will typically have some degree of curvature.

Each of the fibers is formed of a material that is more thermally conductive along its long axis than in a direction that is transverse to the long axis. An example of a suitable material would be carbon fibers. Alternatively the fiber can be a polymer fiber that preferentially transmits heat along its long axis. In one embodiment the fibers are coated with a conductive coating to enhance lateral transmission of heat from an area of fiber to another area in a lateral direction, fiber to fiber or from a fiber to an adjacent surface. In an exemplary embodiment the fibers are coated with a thin metallic coating that may be deposited on the fibers by vapor deposition, sputter deposition, or any other suitable method.

As an example the fibers can be formed from high density polyethylene (HDPE). Some of such fibers have a thermal conductivity of about 20 W/mK (20 Watts per meter degree Kelvin) along the long axis and about 0.2 W/mK along the transverse axis orthogonal to the long axis. These fibers can be coated with a thin metallic coating so that heat is more effectively dispersed in transverse direction for further transmission in longitudinal direction through a larger effective cross section area.

The fibers are permanently attached either to the heat transmission surface 40, the heat receiving surface 44, or to both surfaces 40 and 44 depending upon a particular embodiment. There are various methods for forming such fibers including mechanical attachment, etching into a substrate using a micro etching process, grown on the substrate using a chemical or physical process, and/or formed onto the surface using 3D printing.

The fibers generally have a length that is in a range of 0.3 to 2 millimeters. In another embodiment the length can be in range of 0.3 to 1.0 millimeters. In yet another embodiment the length can be in a range of 0.4 and 0.8 millimeter. In yet another embodiment the fiber length can be about 0.5 millimeter.

The fibers can have a cross sectional diameter or dimension transverse to the long axis of the fiber of within a range of about 5 to 25 μm (micrometers or microns). In one embodiment the cross sectional diameter can be in the range of 5 to 10 μm or 10 μm.

The fiber density can be quite high—about equal to 100,000 to 300,000 fibers per square centimeters or even higher. Thus they have a very close lateral spacing that can be less than 25 μm on average.

FIG. 5 is a schematic representation of an exemplary first embodiment of low force thermal coupler 52 that thermally couples a portion of an housing 30 to a thermally conductive substrate 42 over a heat transfer area 45. Housing 30 includes a very thin compliant layer 58 having an upper surface that defines the heat transmission surface 40. Thermally conductive fibers 60 are permanently attached to heat receiving surface 44. Thermally conductive fibers extend downwardly (−Z direction) to impinge upon heat transmission surface 40.

FIGS. 5A and 5B illustrate the function of thin compliant layer 58. FIG. 5A depicts impingement of a thermally conductive fiber 60 upon a surface 40 which does not have the compliant layer 58 at a microscopic level. As can be seen, the surface 40 is not smooth. Also, it is clear that the fiber 60 generally makes contacts with surface 40 having a small surface area. There is some tendency for the fiber 60 to bend and conform to the surface, thus providing better than point contacts.

FIG. 5B illustrates the use of a very thin compliant layer 58 over housing 30. The compliant layer 58 allows the tip of fiber 60 to have a much larger contact surface area with the surface 40. This may increase the contact surface area by an order of magnitude. Compliant layer 58 is less than 100 μm (microns or micrometers) in thickness as measured in the vertical direction. In other embodiments the thickness of compliant layer 58 can be less than 75 μm, less than 50 μm, or less than 25 μm. In one embodiment compliant layer has a thickness of about 10 to 20 μm. The compliant layer may be formed of a rubber or elastomer having a very low elastic modulus. The increase in surface area of contact is a result of rubber deformation and bending of the fiber at a zone of impingement between fibers 60 and rubber surface 40.

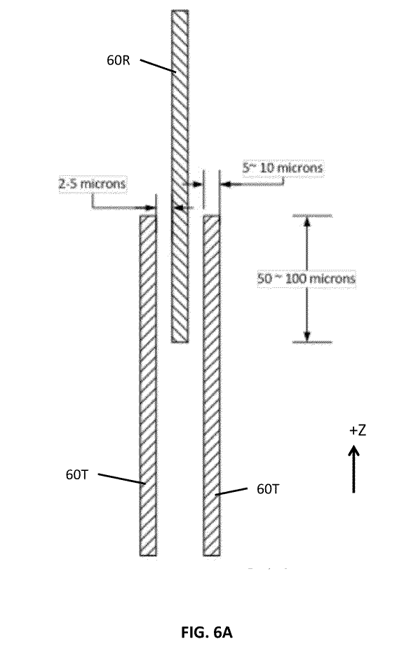

FIG. 6 is a schematic representation of an exemplary second embodiment of low force thermal coupler 52 that thermally couples a portion of an housing 30 to a thermally conductive substrate 42 over a heat transfer area 45. Fibers 60T (T for transmission) project generally along a vertical +Z direction from the heat transmission surface 40 defined by a portion of housing 30. Fibers 60R (R for receiving) generally project along a −Z direction from the heat receiving surface 44 defined by the thermally conductive substrate 42. A vertical zone of overlap 62 is defined by the overlap along the Z axis between fibers 60T and 60R which projects onto the laterally defined heat transfer area 45.

FIG. 6A depicts an exemplary overlap of fibers 60T and 60R to illustrate dimensional detail. A long axis of each fiber is illustrated to be generally vertical or parallel to axis Z. In actuality, of course, the fibers may be curved and/or can define an acute angle with respect to the Z-axis. An effective diameter of each fiber that is measured transverse to the fiber long axis is shown to be in a range of about 5 to 10 μm. The spacing between interleaved or interposed fibers is shown to be in a range of about 2-5 μm. The overlap between 60 T and 60 T fibers along the vertical Z axis is about 50 to 100 μm according to the illustrated embodiment.

The illustrated vertical (Z) overlap between fibers is in a range of between about 10 to 50 times the lateral (X and/or Y) spacing between them. This geometry helps to minimize the thermal resistance for heat being passed from the 60 T transmitting fibers to the 60 R receiving fibers. This thermal resistance can be further reduced by coating the fibers with a metal or other thermally conductive film to improve this lateral heat transfer. The overlap length in comparison to the total fiber length is still very small and hence the force required to cause the overlap is very small resulting in easy coupling and uncoupling which are beneficial for docking and undocking.

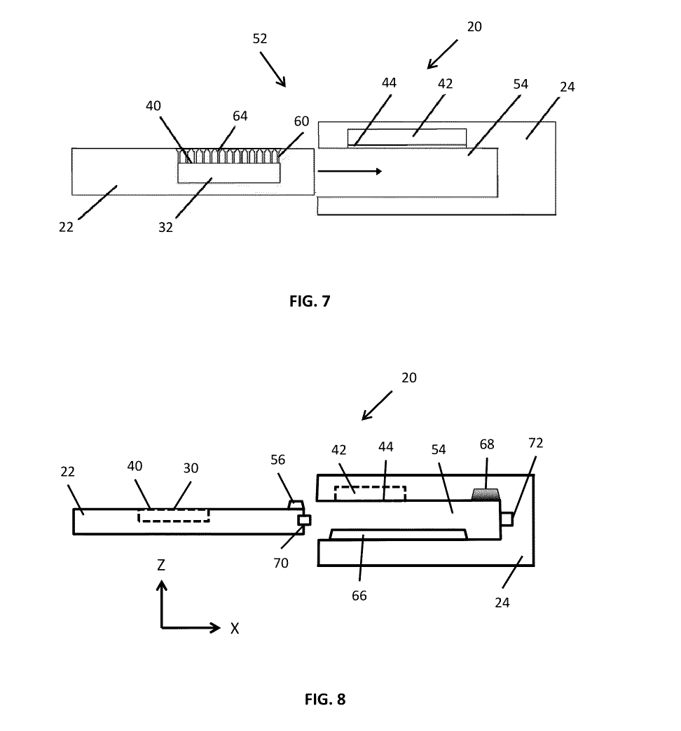

FIG. 7 depicts a system 20 that utilizes a third embodiment of a low force thermal coupler 52. FIG. 7 depicts module 22 to be slidingly installed into receptacle 54 of docking station 24. Module includes a heat transfer element 32 defining a heat transmission surface 40. Fibers 60 project vertically upward (+Z) from heat transmission surface 40. Each of fibers 60 include distal ends 64 having a flared end geometry.

Receptacle 24 includes thermally conductive substrate that defines a heat receiving surface 44. When module 22 is slidingly installed into receptacle 54, the flared distal ends 64 engage the heat receiving surface 44. The flared ends serve to maximize heat transfer from the fibers 60 to the heat receiving surface 44. In one embodiment the heat receiving surface 44 is defined by a thin compliant layer to further enhance the surface area of contact between the flared ends 64 and the heat receiving surface 44. In yet another embodiment each of the flared ends 64 may be coated with a thin conductive material such as a vapor deposited metal to further improve the heat transfer.

FIG. 8 depicts an exemplary system 20 in which a module 22 is about to be installed into receptacle 54 of docking station 24. Module 22 includes at least a portion or datum 56 of housing 30 that engages portions of receptacle 54 to control a vertical positioning module 22 as it slides into receptacle 54. As module 22 slides into receptacle 54 along a lateral X axis, a spring 66 urges module 22 upwardly. An action of datum 56 engaging portions of receptacle 54 opposes the force of spring 66 until datum 56 reaches well 68. Then datum 56 is pushed up into well 68 to allow the low force coupler to thermally couple the heat transmission surface 40 to the heat receiving surface 44. At the same time electrical connectors 70 and 72 couple thereby electrically coupling the modular 22 to docking station 24.

The example of FIG. 8 is greatly simplified and is meant to illustrate the use of surfaces of housing 30 such as datum 56 to control the vertical and angular positioning and motion of module 22 with respect to receptacle 54 when module 22 is laterally inserted into receptacle 54. The interaction of module 22 and receptacle 54 during installation can provide a short sliding motion between surfaces 40 and 44. Consider the embodiment of the low force coupler 52 depicted in FIG. 6. The short sliding motion allows the fibers 60T to settle between gaps of the fibers 60R with a very low force and pressure requirement between the module 22 and the docking station 24.

The interaction of housing 30 of module 22 and surfaces of receptacle 54 control the spacing or distance D (e.g., the perpendicular distance) between heat transmission surface 40 and heat receiving surface 44 along the vertical (Z-axis) direction. In some embodiments embodiment D is in a range of 0.2 to 2.0 millimeter. In other embodiments the distance D is in the range of 0.5 to 1.5 millimeter for an embodiment as depicted in FIGS. 6 and 6A. In other embodiments the distance D is in the range of 0.7 to 1.1 millimeter for an embodiment as depicted in FIGS. 6 and 6A. In yet another embodiment the distance D is about 0.9 millimeter for an embodiment as depicted in FIGS. 6 and 6A. In yet other embodiments D is in a range of 0.3 to 0.7 millimeter for an embodiment as depicted in FIGS. 5, 5A, and 5B. In yet another embodiment D is about 0.5 millimeters. In yet other embodiments D is in a range of 0.3 to 0.7 millimeter for an embodiment as depicted in FIGS. 5, 5A, and 5B. Although other spacing D are possible the controlled spacings are thus optimized according to the use of heat conductive fibers.

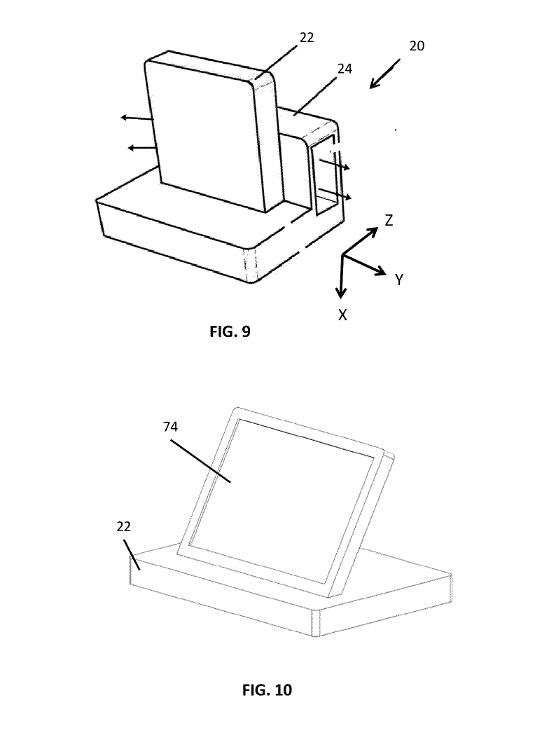

FIG. 9 is an isometric representation of an alternative embodiment of system 20 in which the module 22 is installed in a particular geometric configuration relative to docking station 24. Otherwise functionally system 20 is similar to that depicted with respect to FIGS. 2 and 3. Axes X, Y, and Z are indicated. As before +X is the direction of installation of module 22 into docking station 24 and +Z is the direction of heat transfer from module 22 to docking station 24.

FIG. 10 is an isometric representation of another alternative embodiment of system 20 in which module 22 has an associated small display 74 and can be operated as a computer without being placed into a docking station 24. When operated outside of the docking station 24, module needs to be clocked down or otherwise slowed in to avoid an excessive operating temperature.

In one embodiment module 22 operates with a first processor power level when it is not docked. When the module 22 is installed into the docking station 24, the docking is detected. This module 22 then automatically operates at a higher power level when docked.

While all of the fundamental characteristics and features of the heat dissipating system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful system, various substitutions, modifications, and variations may occur to and be made by those skilled in the art without departing from the spirit or scope of the invention. Consequently, all such modifications and variations and substitutions, as would occur to those skilled in the art are considered included within the scope of the invention as defined by the following claims.

What we claim is:

1. A high power portable device and docking station system (“system”) comprising:
A high power portable device including:
a heat generating apparatus generating at least 8 watts of heat during full load operation;
a housing with at least a portion of area having a thermally conductive surface for thermal coupling to external cooling apparatus;
a thermally conductive heat transfer element thermally coupled to the thermally conductive surface of the housing and the heat generating apparatus for efficient transmission of heat from the heat generating apparatus to the conductive surface of housing;
and
a thermal interface element disposed on the thermally conductive surface of the housing including a means of thermal connectivity capable of providing thermal resistance lower than 10 degree Celsius per square centimeter per watt of heat transmitted to an external array of thermally conductive fibers in contact with it under low pressure and without any need of use of gels, fluids, and grease;
and
A docking station having a means to dissipate heat, and thereby capable of cooling the high power portable device including:
a thermally conductive substrate thermally coupled to the means to dissipate heat;
and
a first array of thermally conductive compliant fibers for accepting the heat through contact with the means of thermal connectivity at one end, permanently disposed on and thermally coupled to the thermally conductive substrate at the other end, thereby capable of cooling the high power portable device.

2. A high power portable device comprising:
a heat generating apparatus generating at least 8 watts of heat during full load operation;
a housing with at least a portion of area having a thermally conductive surface for thermal coupling to external cooling apparatus;
a thermally conductive heat transfer element thermally coupled to the thermally conductive surface of the housing and the heat generating apparatus for efficient transmission of heat from the heat generating apparatus to the conductive surface of housing;
and
a thermal interface element disposed on the thermally conductive surface of the housing including a means of thermal connectivity capable of providing thermal resistance lower than 10 degree Celsius per square centimeter per watt of heat transmitted to an external array of thermally conductive fibers when in contact with it under low pressure and without any need of use of gels, fluids, and grease;

3. A Docking station having a means to dissipate heat, and thereby capable of cooling the high power portable device including:
a thermally conductive substrate thermally coupled to the means to dissipate heat; and
an array of thermally conductive compliant fibers for accepting the heat through contact with the means of thermal connectivity at one end, permanently disposed on and thermally coupled to the thermally conductive substrate at the other end, thereby capable of cooling the high power portable device.

4. The high power device in claim 2 wherein the means of thermal connectivity comprises of a second array of thermally conductive fibers permanently disposed on and thermally coupled to the thermal interface element.

5. The high power device in claim 2 wherein the means of thermal connectivity comprises of a compliant coating permanently disposed on the thermally conductive surface, with such low coating thickness that it provides greater contact surface area to an external array of compliant and thermally conductive fibers under low pressure contact, thereby reducing the thermal contact resistance, while still keeping the increase in thermal resistance due to additional layer low enough so that the overall thermal resistance is below 10 degree Celsius per watt per square centimeter.

6. The system in claim 1 wherein the means of thermal connectivity comprises of a second array of thermally conductive fibers permanently disposed on and thermally coupled to the thermal interface element, such that it creates an overlapping contact with the first array of thermally conductive fibers of the docking station when in contact under low pressure.

7. The system in claim 1 wherein the means of thermal connectivity comprises of a compliant coating permanently disposed on the thermally conductive surface, with such low coating thickness that it provides greater contact surface area to the first array of compliant and thermally conductive fibers of the docking station under low pressure impinging contact, thereby reducing the thermal contact resistance, while still keeping the increase in thermal resistance due to additional layer low enough so that the overall thermal resistance is below 10 degree Celsius per watt per square centimeter.

8. The high power portable device in claim 4 wherein the high power portable device is a high performance portable computer wherein the heat generating apparatus is the PC Board that includes a CPU.

9. The high power portable device in claim 5 wherein the high power portable device is a high performance portable computer wherein the heat generating apparatus is the PC Board that includes a CPU.

10. The high power portable device in claim 4 wherein each of the thermally conductive fibers conducts heat most effectively along a long axis of the fiber and many fibers include an outer coating that enhances thermal conduction into the fiber in directions that are transverse to the long axis of the fiber.

11. The docking system in claim 3 wherein each of the thermally conductive fibers conducts heat most effectively along a long axis of the fiber and many fibers include an outer coating that enhances thermal conduction into the fiber in directions that are transverse to the long axis of the fiber.

12. The system in claim 1 wherein the at least the partial engagement of the outer housing with the thermally conductive substrate controls spacing between the thermal interface element of the portable device and the thermally conductive substrate of the docking station.

13. The system in claim 12 wherein the engagement controls a sliding engagement whereby a sliding motion is established between the thermally coupled thermally conductive fibers of the docking station and the thermal interface element.

14. The system in claim 6 wherein the overlap length between the first array of fibers and the second array of thermally conductive fibers is much smaller than length of either array of fibers, thereby requiring low pressure for causing overlap, while still increasing the effective surface area of contact between both array of fibers by orders of magnitude with average air gap of less than 10 microns between the overlapping surfaces of fibers, so that the effective thermal resistance between the arrays of fibers is reduced significantly.

15. The system in claim 13 wherein an interaction between the thermal interface element and the array of thermally conductive fibers result in a scrubbing motion of the thermally conductive fibers to improve the thermal contact between the thermally conductive fibers and the thermal interface element.

16. The system in claim 1 wherein the means to dissipate heat includes a heatsink and a fan and the outer surfaces of the docking station.

17. The system in claim 1 wherein the means to dissipate heat includes directly coupled cold side piping of a refrigeration cycle system, suitably adapted from split air-conditioning system.

18. The system in claim 1 wherein the high power portable device is a high performance portable computer wherein the heat generating apparatus is the PC Board that includes a CPU.
